(19) United States
(12) Patent Application Publication
(10) Pub. No.: US 2016/0218958 A1
(43) Pub. Date: Jul. 28, 2016

(54) METHOD AND SYSTEM FOR FORWARDING PACKET IN ID/LOCATOR SEPARATION ENVIRONMENT

(71) Applicant: ELECTRONICS AND TELECOMMUNICATIONS RESEARCH INSTITUTE, Daejeon (KR)

(72) Inventor: Joo Chul Lee, Daejeon (KR)

(73) Assignee: ELECTRONICS AND TELECOMMUNICATIONS RESEARCH INSTITUTE, Daejeon (KR)

(21) Appl. No.: 14/994,234

(22) Filed: Jan. 13, 2016

(30) Foreign Application Priority Data
Jan. 28, 2015 (KR) 10-2015-0013279

(51) Int. Cl. H04L 12/755; H04L 12/66

(52) U.S. Cl. CPC H04L 45/021; H04L 12/66

(57) ABSTRACT

Disclosed is a method for communication between a first terminal and a second terminal located in a single domain in an identifier/locator separation environment. The method includes: updating a locator by the second terminal in association with a domain gateway in the domain; and generating a forwarding table for the second terminal by the first terminal and performing a communication by the first terminal and the second terminal by using the forwarding table.

### CROSS-REFERENCE TO RELATED APPLICATION

This application claims the benefit of priority to Korean Patent Application No. 10-2015-0013279, filed on Jan. 28, 2015 in the Korean Intellectual Property Office, the disclosure of which is incorporated herein in its entirety by reference.

### BACKGROUND OF THE INVENTION

1. Field of the Invention

The present disclosure relates to a method and a system for communication between end-hosts within a local domain in an identifier/locator separation environment, and more particularly, to a technology for communication between end-hosts within the same local domain.

2. Description of the Related Art

A current communication structure of the Internet is an end-to-end structure in which an internet protocol address (IP Address) which is the basis of an identifier is assigned to an end-host and a communication between hosts is performed based on the assigned IP Address.

In the communication structure of the Internet, the IP address is assigned to an interface of each host and a communication node. When a sender desires to transmit data to a receiver, the data containing transmission information includes a header that contains control information. Here, the header includes the IP address of the sender and the IP address of the receiver.

Next, a data transmission method in a network determines a routing path in a network based on a transmission IP address that the header includes.

A conventional data transmission method in the Internet is designed in consideration of Internet environment which is configured of a small number of fixed hosts, which may lead to inefficiencies in a mobile environment-oriented network environment which is configured of several billion mobile hosts or more. Such inefficiencies are as follows.

First, in the current internet configured based on a fixed environment, a locator, i.e., an IP address, that indicates a position in which a corresponding host is located should be assigned with respect to a mobile host. However, the method of assigning fixed information with respect to the mobile host, when the locator of the mobile host can be changed any time as the position of the mobile host is changed in the mobile environment, may lead to inefficiency, such as a reconfiguration of a locator or the like, and a degradation of communication performance.

Second, in the current internet, an identifier for identifying the communication connectivity and the locator information for the transmission of actual data are integrated in the IP address. This may not be a problem in the fixed environment, but it is not a proper structure in a mobile environment in which the identifier should be fixed for service continuity and the identifier should be changed frequently depending on the position movement, which may require an inefficient additional process.

That is, the existing structure in which the identifier and the locator are integrated is inefficient in various services to support a technology such as multi-homing, mobility, and the like.

In recent years, it is required to separate the overlap of the identifier (ID) and the locator of the existing IP address, and a technology for mapping the identifier and the locator for separating the identifier and the locator has been also developed.

### SUMMARY OF THE INVENTION

The present disclosure has been made in view of the above problems, and provides a method and a system for enabling a communication between end-hosts in the same local domain in an identifier/locator separation environment.

In accordance with an aspect of the present disclosure, a method for communication between a first terminal and a second terminal located in a single domain in an identifier/locator separation environment includes: updating a locator by the second terminal in association with a domain gateway in the domain; and generating a forwarding table for the second terminal by the first terminal and performing a communication by the first terminal and the second terminal by using the forwarding table. When the domain gateway receives a location confirmation message from the second terminal, updating a locator by the second terminal includes requesting a location update to a mapping system and registering the second terminal in a local host list. The location confirmation message includes a locator of the second terminal that is a transmission terminal, and a local domain address of the domain to which the second terminal belongs. Performing a communication by the first terminal and the second terminal includes: determining, by the first terminal, whether the forwarding table entry for the second terminal exists in the first terminal; and transmitting a packet to the second terminal according to the forwarding entry, when the forwarding table entry for the second terminal exists in the first terminal. Transmitting a packet to the second terminal includes: determining, by the first terminal, whether an external transmission interface of the forwarding table entry for the second terminal is set; setting the external transmission interface by using a local domain routing table by the first terminal, when the external transmission interface is not set; and transmitting the packet to the second terminal by using forwarding table entry information including the external transmission interface, by the first terminal. When the forwarding table entry for the second terminal does not exist in the first terminal, determining whether the forwarding table entry for the second terminal exists includes transmitting the packet to the domain gateway; determining, by the domain gateway, whether the forwarding table entry for the second terminal that is a destination exists in the domain gateway; and transmitting the packet to the second terminal according to the forwarding table entry for the second terminal, when the forwarding table entry for the second terminal exists in the domain gateway. When the forwarding table entry for the second terminal does not exist in the domain gateway, determining whether the forwarding table entry for the second terminal exists in the domain gateway includes: determining, by the domain the gateway, whether an identifier of the second terminal is registered in a local host list; transmitting a local resolve message to the first terminal by the domain gateway when the second terminal is registered in the local host list; and transmitting a packet received from the first terminal to the second terminal by the domain gateway. The local resolve message includes an identifier of a second terminal that is a destination end-host, a local domain protocol of a domain to which the second terminal belongs, and a local domain address. The method further includes generating a local forwarding table entry for the second terminal by the first terminal which received the local resolve message. The method further includes transmitting a packet directly to the second terminal by using the local forwarding table entry for the second terminal, when the first terminal desires to transmit the packet to the second terminal. The local forwarding table entry includes an identifier of the second terminal that is a destination, an external transmission interface, a local domain protocol of a domain to which the second terminal belongs, and a local domain address of the domain to which the second terminal belongs.

In accordance with another aspect of the present disclosure, a system for performing a communication between a first terminal and a second terminal located in a single domain in an identifier/locator separation environment includes: a local host list configured to register all terminals belonging to the domain; a register configured to update a locator in association with a mapping system when receiving a location confirmation message from the second terminal, and register the second terminal in the local host list; and a controller configured to determine whether the second terminal is registered in the local host list, when receiving a request for transmitting a packet from the first terminal to the second terminal, and transmitting a local resolve signal to the first terminal and transmitting the packet to the second terminal when the second terminal is registered in the local host list. The controller determines whether a packet is the location confirmation message when the packet is received from the first terminal, determines whether a forwarding table entry for the second terminal exists when the packet is not the location confirmation message, and transmits the packet according to the forwarding table entry when the forwarding table entry exists. When the forwarding table entry does not exist, it is determined whether the second terminal is registered in the local host list. The local forwarding table entry includes an identifier of the second terminal that is a destination, an external transmission interface, a local domain protocol of a domain to which the second terminal belongs, and a local domain address of the domain to which the second terminal belongs.

### BRIEF DESCRIPTION OF THE DRAWINGS

The objects, features and advantages of the present disclosure will be more apparent from the following detailed description in conjunction with the accompanying drawings, in which:

FIG. 1 is a diagram illustrating a communication environment of a communication system between end-hosts in a local domain of an identifier/locator separation environment according to an embodiment of the present disclosure;

FIG. 2 is a diagram illustrating a detailed configuration of a domain gateway of FIG. 1;

FIG. 3 is a detailed configuration of a terminal of FIG. 1;

FIG. 4 is a flow chart illustrating a method of communication between end-hosts in a local domain of an identifier/locator separation environment according to an embodiment of the present disclosure;

FIG. 5 is a flow chart illustrating an operation of a transmission terminal of FIG. 4 in detail; and

FIG. 6 is a flow chart illustrating an operation of a domain gateway of FIG. 4.

### DETAILED DESCRIPTION OF EXEMPLARY EMBODIMENTS

Exemplary embodiments of the present disclosure are described with reference to the accompanying drawings in detail. The same reference numbers are used throughout the drawings to refer to the same or like parts. Detailed descriptions of well-known functions and structures incorporated herein may be omitted to avoid obscuring the subject matter of the present disclosure.

The present disclosure discloses a technology of communication between end-hosts in a local domain of an identifier/locator separation environment.

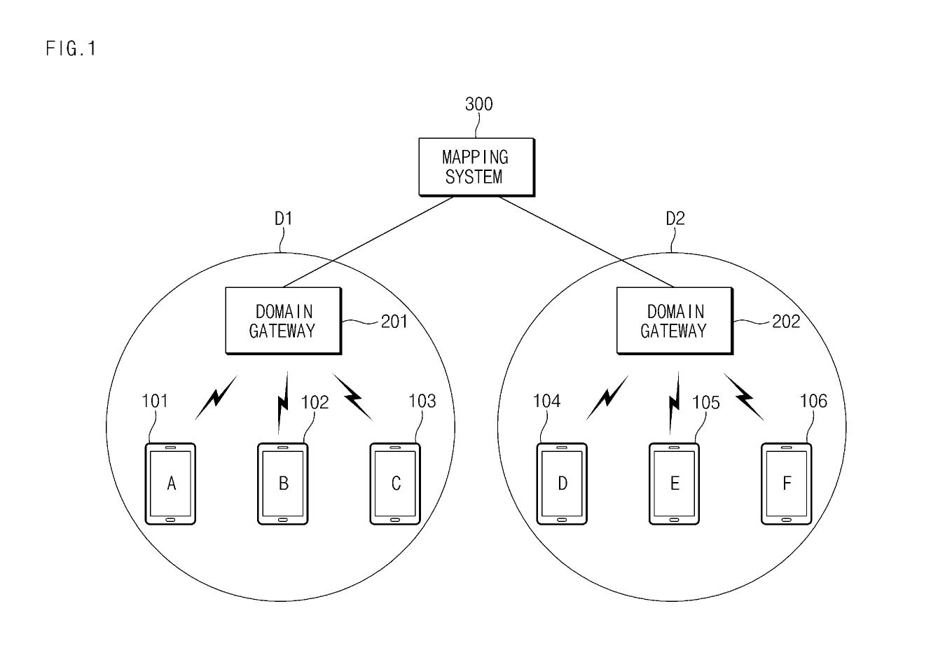

Hereinafter, embodiments of the present disclosure are described in detail with reference to FIG. 1 to FIG. 6.

FIG. 1 is a diagram illustrating a communication environment of a communication system between end-hosts in a local domain of an identifier/locator separation environment according to an embodiment of the present disclosure.

The present disclosure may be applied in a network environment which is a hierarchical domain in an identifier/locator separation environment, and each domain may be defined as a group of nodes having similar features. Each domain may be configured of nodes that use physically same transport protocol, and may be extended to a group of nodes that have a local common or a similar communication purpose. An identifier of domain may be given to each domain, and the identifier itself may be just a bit stream value that has no meaning. However, if the identifier of domain is connected, it may have relative position information, and may serve as a locator of a node belonging to a specific domain. Thus, the present disclosure may use a value of this locator when border routers (domain gateway) of each domain perform a routing protocol operation between domains in the identifier/locator separation environment.

Referring to FIG. 1, a domain gateway 201 and a plurality of terminals 101 to 103 exist in a domain D1, and a domain gateway 202 and a plurality of terminals 104 to 106 exist in a domain D2. In this case, it is illustrated that a single domain gateway is provided for each domain, but a plurality of domains may be provided for a single domain. In addition, the plurality of terminals may include a wired terminal such as an internet terminal as well as a wireless terminal, and are not limited to the number shown in FIG. 1 but may be arranged in various numbers.

Respective terminals 101 to 106 may have their own identifiers and locators as an end-host, the terminals 101 to 103 included in the domain D1 may register their own identifiers and locators in a mapping system 300 via the domain gateway 201 in the domain D1, and the terminals 104 to 106 included in the domain D2 may register their own identifiers and locators in the mapping system 300 via the domain gateway 202 in the domain D2.

The terminals 101 to 106 may be able to freely move between domains D1 and D2, and may perform an update of the locator by sending a location confirmation message to the domain gateway in the domain of the current position. At this time, the domain gateways 201 and 202 may perform the update of the locator in association with the mapping system 300.

For example, when the terminal 104 moves to the domain D1 from the domain D2, or when the terminal 104 is turned on first in the domain D1, the terminal 104 may transmit a location confirmation message (IDP_PRESENT) to the domain gateway 201 within the domain D1 to notify that the terminal 104 is added to a corresponding domain. Thus, the domain gateway 201 may update the locator for the newly entered terminal 104 in association with the mapping system 300 and register the terminal 104 in a local host list of the domain gateway 201.

In this case, the location confirmation message may include the identifier (the identifier of the terminal 104) of the host that transmitted the location confirmation message, and the protocol address (the local domain address of the domain D1 to which the terminal 104 belongs) in the domain of the host that transmitted the location confirmation message. At this time, the local domain address may become an IP address in the case of the IP domain, and may become an Ethernet address in the case of the Ethernet domain.

The mapping system 300 may be a system that manages the mapping of the identifier and the locator, and provide the locator mapped to an identifier value when the domain gateway 201, 202 queries with the identifier value. That is, when receiving a locator update message (IDP_LOC_UPDATE) from the domain gateway 201, 202, the mapping system 300 may map and register a new locator to a corresponding identifier. At this time, the locator update message (IDP_LOC_UPDATE) may include an identifier of the host (terminal), and the locator of the domain.

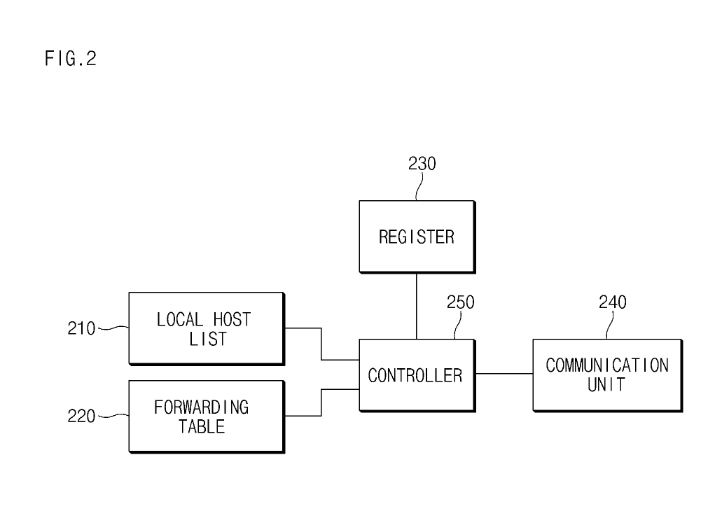

FIG. 2 is a diagram illustrating a detailed configuration of a domain gateway 201, 202 of FIG. 1.

The domain gateway 201, 202 may include a local host list 210, a forwarding table 220, a register 230, a controller 250, and a communication unit 240.

The local host list 210 may be a list registering each terminal belonging to the domain managed by the domain gateway 201, 202.

The forwarding table 220 may have information of a reception interface of the next domain gateway 201, 202 through which packet should pass in order to go to the identifier of a destination of the packet. In this case, the reception interface information may include next hop information: an external transmission interface, a protocol of the reception interface (e.g. IP, Ethernet . . . ), and an address (e.g. IPv4 address, Ethernet address, IPv6 address . . . ) assigned to the reception interface.

When receiving the location confirmation message from the terminal, the register 230 may perform the update of the locator in association with the mapping system 300 and register the terminal which transmitted the location confirmation message to the local host list 210.

The communication unit 240 may perform a communication with the terminals within the domain, and the map system 300, and may perform a wired or wireless communication.

When the controller 250 is requested to transmit packet from the terminal A 101 of the domain D1 to the terminal C 103, the controller 250 may determine whether a forwarding table entry for the terminal C 103 exists in the forwarding table 220, and transmit the packet to the terminal C 103 based on the forwarding table entry, when the forwarding table entry for the terminal C 103 exists in the forwarding table 220.

On the other hand, when the forwarding table entry for the terminal C 103 does not exist in the forwarding table 220, the controller 250 may determine whether the identifier for the terminal C 103 is registered in the local host list 210. Thereafter, when the identifier for the terminal C 103 is registered in the local host list 210, the controller 250 may transmit a local resolve message (IDP_LOCAL_RESOLVE) to the terminal A 101 that requested the packet transmission, and may forward the packet received from the terminal A 101 to the terminal C 103. At this time, the local resolve message may include an identifier (an identifier of terminal C 103) of a destination end-host, a type of protocol (a local domain protocol of the domain D1 to which the terminal C 103 belongs) specified to the domain to which the destination end-host belongs, and a protocol address value (a local domain address of the domain D1 to which the terminal C 103 belongs) specified to the domain to which the destination end-host belongs.

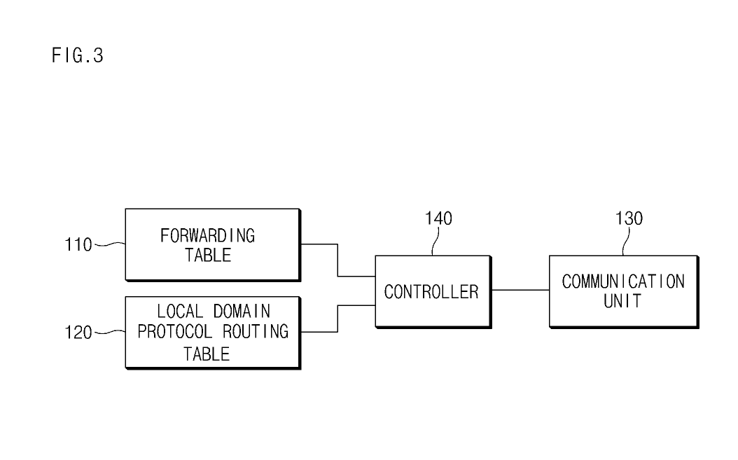

FIG. 3 is a detailed configuration of terminals 101 to 106 of FIG. 1.

The terminals 101 to 106 may include a forwarding table 110, a local domain protocol routing table 120, a communication unit 130, and a controller 140.

The forwarding table 110 may be a table that stores information on a next hop through which packet should pass in order to go to the identifier of a destination of the packet from a current domain gateway. The next hop information is residual information except for a destination identifier in Table 1. That is, as shown in Table 1, the next hop information may include an external transmission interface, a protocol of the next hop domain gateway, and an address of the next hop domain gateway.

TABLE 1

| | | | |
|---|---|---|---|
| Destination | External | Protocol type | Address of |
| identifier | transmission | of next hop | next hop |
| | interface | domain | domain |
| | (e.g. eth0) | gateway (e.g. | gateway (e.g. |
| | | IP) | IP address) |

The local domain protocol routing table 120 may store information such as a network address of destination node, egress port information of a router, and a metrics for the calculation of optimum path.

The communication unit 130 may perform communication of a wireless terminal or a wired terminal.

The control unit 140 may determine whether a forwarding table entry for the destination identifier exists in the forwarding table 110 when desiring to transmit a packet, and transmit the packet to the domain gateway 201, 202 when the forwarding table entry does not exist in the forwarding table 110. When a forwarding table entry for the destination identifier exists in the forwarding table 110, the control unit 140 may determine whether an external transmission interface of the forwarding table entry is set, and transmit the packet to the destination by using the information of the forwarding table entry when the external transmission interface is set. On the other hand, when the external transmission interface is not set, the external transmission interface may be set by referring to the local domain protocol routing table 120 of an intra-domain protocol.

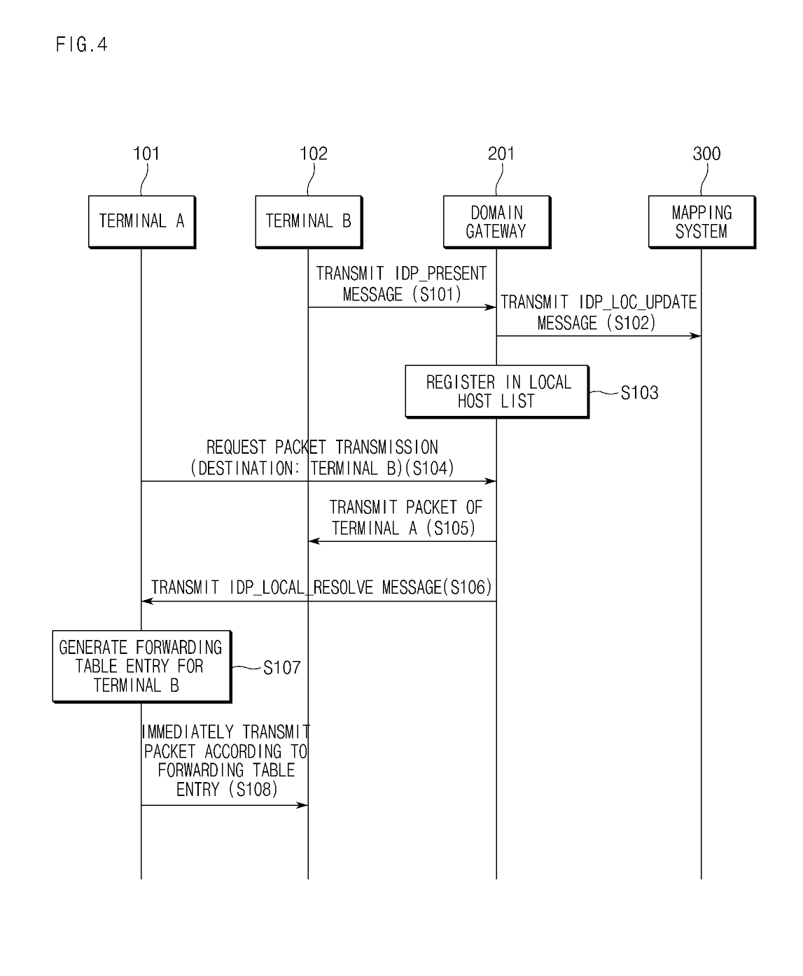

Hereinafter, referring to FIG. 4, a method of communication between end-hosts in a local domain of an identifier/locator separation environment according to an embodiment of the present disclosure is described in detail.

It is illustrated that the terminal A 101 that is a transmission terminal transmits packet to the terminal B 102 that is a reception terminal.

In this case, it is illustrated that the terminal A 101 is located in the local domain D1 according to the domain gateway 201 and is already registered in the local host list of the domain gateway 201, and the terminal B is not registered in the local host list of the domain gateway 201 of the local domain D1.

First, the terminal B 102 may transmit a location confirmation message (IDP_PRESENT) to the domain gateway 201 within the local domain D1 in order to update its own locator (S101). In this case, the location confirmation message (IDP_PRESENT) is a message for requesting the update of the current position for the identifier of the terminal B to the domain gateway 201, and includes the identifier of the terminal B 102.

Thus, the domain gateway 201 may transmit a locator update message (IDP_LOC_UPDATE) to the mapping system 300 in order to map the locator of the current domain to the identifier of terminal B 102 (S102). At this time, the locator update message (IDP_LOC_UPDATE) may include the identifier and the locator of the terminal B 102. Here, gateway information of the local domain may be automatically set when a dynamic host configuration protocol (DHCP) method or the like boots.

Then, the domain gateway 201 may register the identifier of the terminal B 102 that transmitted the location confirmation message (IDP_PRESENT) and the protocol address in the domain in which the terminal B 102 is located in the local host list (S103). At this time, the locator may include an IP address in the case of an IP domain as the local domain address, and may include an Ethernet address in the case of the Ethernet domain.

As described above in the process of S101 to S103, after the terminal B 102 is registered in the domain gateway 201, if the terminal A 101 requests the transmission of a packet to the terminal B 102 to the domain gateway 201 (S104), the domain gateway 201 may transmit the packet received from the terminal A 101 to the terminal B 102.

Then, the domain gateway 201 may transmit a local resolve message (IDP_LOCAL_RESOLVE) to inform that the terminal B exists in the same local domain to the terminal A 101 (S106).

In this case, the domain gateway 201 may transmit the packet that has been transmitted to the domain gateway 201 before the terminal A 101 generates a forwarding table entry for the terminal B 102 to the terminal B 102. To this end, the domain gateway 201 may also generate a temporary forwarding table entry.

Then, when receiving the local resolve message (IDP_LOCAL_RESOLVE), the terminal A 101 may determine that the terminal B 102 is located within the same local domain and may generate a forwarding table entry for the terminal B 102 (S107). At this time, the forwarding table entry may include path information to the terminal B 102 within the local domain D1.

Then, when transmitting the packet to the terminal B 102, the terminal A 101 may immediately transmit the packet directly to the terminal B 102 according to the generated forwarding table entry (S108).

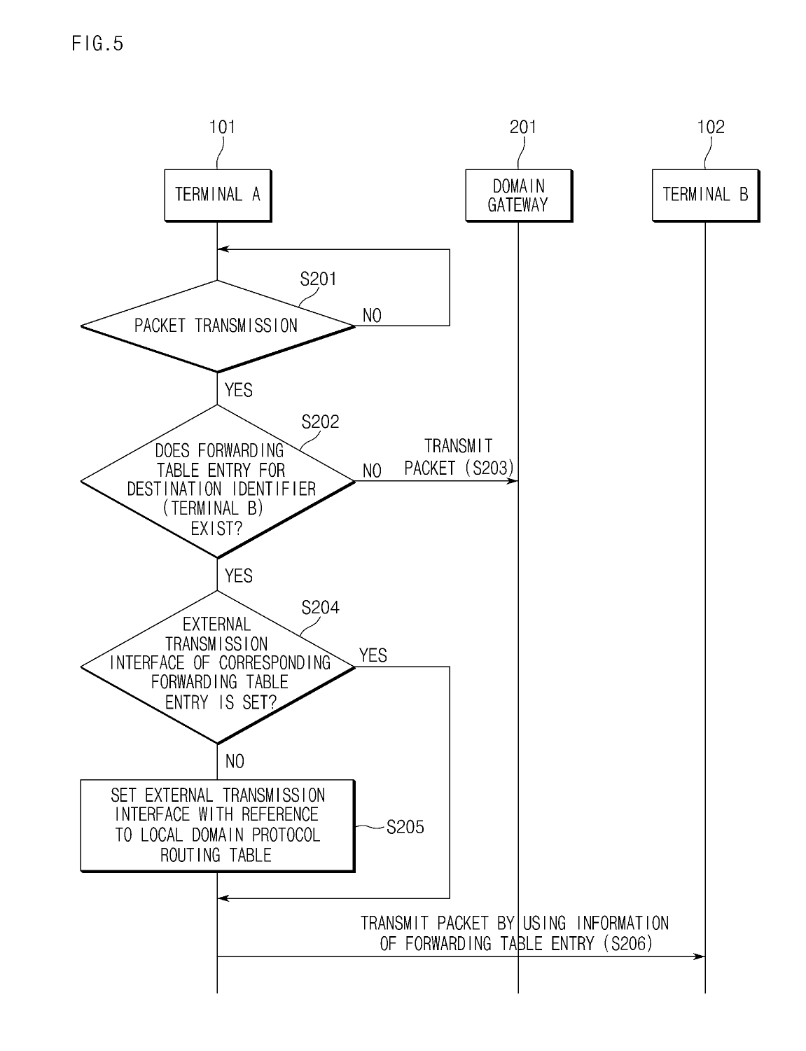

Hereinafter, the operation of the transmission terminal of FIG. 4 is described in detail with reference to FIG. 5.

It is determined whether a packet to be transmitted by the terminal A 101 that is a transmission terminal exists (S201). If the packet to be transmitted exists, the terminal A 101 may determine whether a forwarding table entry for the destination identifier (terminal B) exists in the terminal A 101 (S202).

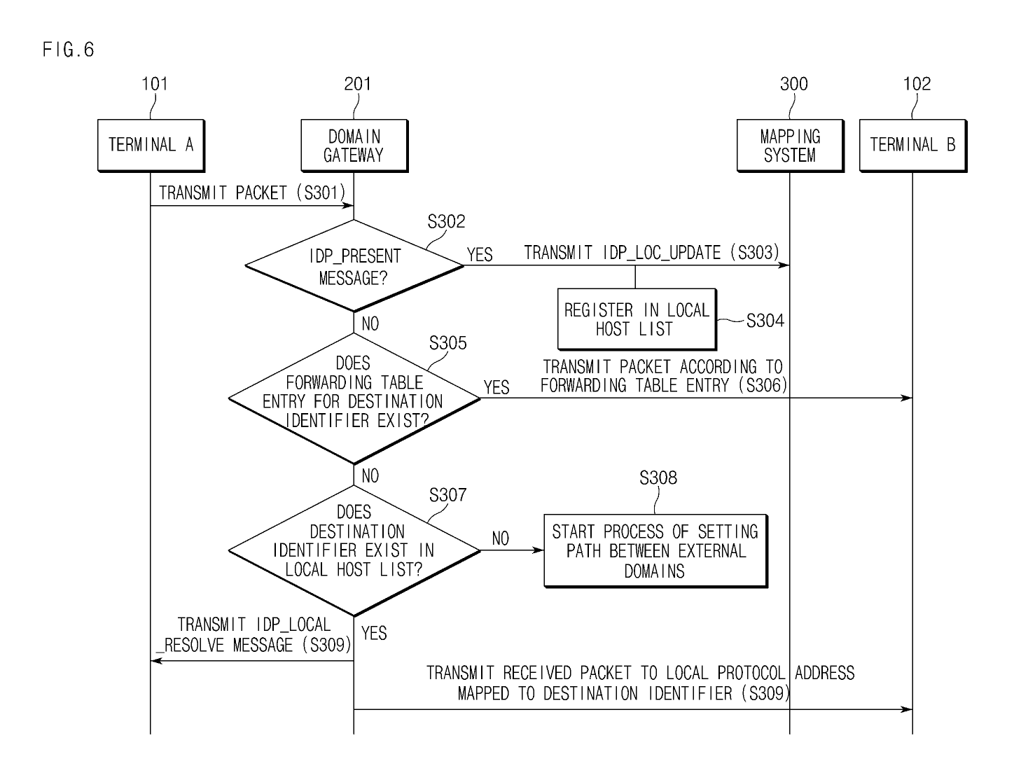

If the forwarding table entry for the destination identifier (terminal B) does not exist, the terminal A 101 may transmit a corresponding packet to the domain gateway 201 (S203). Next process is described in detail in the operation description of the domain gateway 201 of FIG. 6.

On the other hand, if the forwarding table entry for the destination identifier (terminal B) exists, the terminal A 101 may determine whether an external transmission interface of a corresponding forwarding table entry is set (S204). At this time, the external transmission interface may be indicated as eth0, eth1, . . . and the like. For example, it means the external transmission interface that is included in next hop information of the forwarding table corresponding to the destination identifier (destination ID) included in the header of the packet received to eth0.

In this case, the next hop information refers to information of the next domain gateway to reach to go to a corresponding destination identifier. That is, the external transmission interface means an interface through which packets are transmitted to the next-hop domain gateway

When the external transmission interface of the forwarding table entry is not set, the terminal A 101 may set the external transmission interface with reference to the local domain protocol routing table 120 (S205).

The terminal A 101 may transmit the packet to the terminal B 102 by using the information of the forwarding table entry in which the external transmission interface is set (S206).

Hereinafter, the operation of the domain gateway of FIG. 4 is described in detail with reference to FIG. 6.

When receiving a packet from the terminal A 101 (S301), the domain gateway 201 may determine whether the received packet is a location confirmation message (IDP_PRESENT) (S302).

When the received packet is a location confirmation message, the domain gateway 201 may transmit a locator update message (IDP_LOC_UPDATE) to the mapping system 300 in order to update a locator (S303).

Then, the domain gateway 201 may register the terminal A 101 in its own local host list (S304).

On the other hand, when the received packet is not a location confirmation message (IDP_PRESENT), the domain gateway 201 may determine whether a forwarding table entry for the destination identifier (terminal B) exits (S305).

When the forwarding table entry for the destination identifier (terminal B) exits, the domain gateway 201 may transmit the packet to the terminal B 102 which is a destination according to the forwarding table entry (S306).

On the other hand, when the forwarding table entry for the destination identifier (terminal B) does not exit, the domain gateway 201 may determine whether the destination identifier exists in the local host list (S307).

When the destination identifier does not exist in the local host list, the domain gateway 201 may perform a process of setting a path between external domains. Since the process of setting a path between external domains means a conventional normal path setting process, a detailed description is omitted in the present disclosure.

On the other hand, when the destination identifier exists in the local host list, the domain gateway 201 may transmit a local resolve message (IDP_LOCAL_RESOLVE) to inform that the terminal B 102 that is a destination identifier exists in the same local domain to the terminal A 101 (S309).

Then, the domain gateway 201 may transmit the packet to the terminal B 102 that is a destination identifier by using a local protocol address mapped to the destination identifier (S310).

As described above, the present disclosure may enable a communication between end-hosts belonging to the same local domain in an identifier/locator separation environment.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A method for communication between a first terminal and a second terminal located in a single domain in an identifier/locator separation environment, the method comprising:
updating a locator by the second terminal in association with a domain gateway in the domain; and
generating a forwarding table for the second terminal by the first terminal and performing a communication by the first terminal and the second terminal by using the forwarding table.

2. The method of claim 1, wherein updating a locator by the second terminal comprises, when the domain gateway receives a location confirmation message from the second terminal, requesting a location update to a mapping system and registering the second terminal in a local host list.

3. The method of claim 2, wherein the location confirmation message comprises a locator of the second terminal that is a transmission terminal, and a local domain address of the domain to which the second terminal belongs.

4. The method of claim 1, wherein performing a communication by the first terminal and the second terminal comprises:
determining, by the first terminal, whether the forwarding table entry for the second terminal exists in the first terminal; and
transmitting a packet to the second terminal according to the forwarding entry, when the forwarding table entry for the second terminal exists in the first terminal.

5. The method of claim 4, wherein transmitting a packet to the second terminal comprises:
determining, by the first terminal, whether an external transmission interface of the forwarding table entry for the second terminal is set;
setting the external transmission interface by using a local domain routing table by the first terminal, when the external transmission interface is not set; and
transmitting the packet to the second terminal by using forwarding table entry information including the external transmission interface, by the first terminal.

6. The method of claim 4, wherein determining whether the forwarding table entry for the second terminal exists, when the forwarding table entry for the second terminal does not exist in the first terminal, comprises:
transmitting the packet to the domain gateway;
determining, by the domain gateway, whether the forwarding table entry for the second terminal that is a destination exists in the domain gateway; and
transmitting the packet to the second terminal according to the forwarding table entry for the second terminal, when the forwarding table entry for the second terminal exists in the domain gateway.

7. The method of claim 6, wherein determining whether the forwarding table entry for the second terminal exists in the domain gateway, when the forwarding table entry for the second terminal does not exist in the domain gateway, comprises:
determining, by the domain the gateway, whether an identifier of the second terminal is registered in a local host list;
transmitting a local resolve message to the first terminal by the domain the gateway when the second terminal is registered in the local host list; and
transmitting a packet received from the first terminal to the second terminal by the domain gateway.

8. The method of claim 7, wherein the local resolve message comprises an identifier of a second terminal that is a destination end-host, a local domain protocol of a domain to which the second terminal belongs, and a local domain address.

9. The method of claim 6, further comprising generating a local forwarding table entry for the second terminal by the first terminal which received the local resolve message.

10. The method of claim 9, further comprising transmitting a packet directly to the second terminal by using the local forwarding table entry for the second terminal, when the first terminal desires to transmit the packet to the second terminal.

11. The method of claim 10, wherein the local forwarding table entry comprises an identifier of the second terminal that is a destination, an external transmission interface, a local domain protocol of a domain to which the second terminal belongs, and a local domain address of the domain to which the second terminal belongs.

12. A system for performing a communication between a first terminal and a second terminal located in a single domain in an identifier/locator separation environment, the system comprising a domain gateway comprising:
a local host list configured to register all terminals belonging to the domain;
a register configured to update a locator in association with a mapping system when receiving a location confirmation message from the second terminal, and register the second terminal in the local host list; and
a controller configured to determine whether the second terminal is registered in the local host list, when receiving a request for transmitting a packet from the first terminal to the second terminal, and transmitting a local resolve signal to the first terminal and transmitting the packet to the second terminal when the second terminal is registered in the local host list.

13. The system of claim 12, wherein the controller determines whether a packet is the location confirmation message when the packet is received from the first terminal, determines whether a forwarding table entry for the second terminal exists when the packet is not the location confirmation message, and transmits the packet according to the forwarding table entry when the forwarding table entry exists.

14. The system of claim 13, wherein, when the forwarding table entry does not exist, it is determined whether the second terminal is registered in the local host list.

15. The system of claim 12, wherein the local forwarding table entry comprises an identifier of the second terminal that is a destination, an external transmission interface, a local domain protocol of a domain to which the second terminal belongs, and a local domain address of the domain to which the second terminal belongs.
